(19) United States
(12) Patent Application Publication
(10) Pub. No.: US 2011/0267563 A1
(43) Pub. Date: Nov. 3, 2011

(54) LIGHT GUIDE, SURFACE LIGHT SOURCE DEVICE, AND LIQUID CRYSTAL DISPLAY DEVICE

(75) Inventor: Takaharu Shimizu, Osaka-shi (JP)

(73) Assignee: Sharp Kabushiki Kaisha, Osaka-shi (JP)

(21) Appl. No.: 13/143,389

(22) PCT Filed: Oct. 6, 2009
(86) PCT No.: PCT/JP2009/067418

§ 371 Date: Jul. 6, 2011

(30) Foreign Application Priority Data
Feb. 17, 2009 (JP) 2009-034275

(51) Int. Cl. G02F 1/13357; F21V 7/22

(52) U.S. Cl. 349/65; 362/606

(57) ABSTRACT

A light guide of the present invention is excellent in luminance uniformity and can have a reduction in the number of components and a reduction in production cost. The light guide of the present invention includes a main body of a light guide plate having a light incident plane and a light exit plane, and a distance maintaining section (10) for maintaining a distance between the light exit plane and an optical member for receiving light emitted from the light exit plane, the distance maintaining section (10) being provided on the light exit plane, the optical member being placed to face the light exit plane, and the distance maintaining section (10) (i) extends from the light exit plane to the optical member, (ii) has a length of not less than 0.3 mm but not more than 50 mm in a direction in which the light exit plane and the optical member are connected to each other via the distance maintaining section (10), and (iii) is provided integral with the main body of the light guide plate.

### TECHNICAL FIELD

The present invention relates to a light guide, a surface light source device employing the light guide, and a liquid crystal display device employing the light guide. More specifically, the present invention relates to a light guide which (i) is excellent in luminance uniformity and (ii) can have a reduction in the number of components and a reduction in production cost, a surface light source which (a) employs the light guide and (b) is used as a backlight of a liquid crystal display device or the like, and a liquid crystal display device employing the surface light source device.

### BACKGROUND ART

These days, cathode ray tube (CRT) devices are rapidly being replaced with liquid crystal display devices. Liquid crystal display devices have advantages of low power consumption, a thin and light-weight body, and other advantages, and are therefore widely used in various devices, such as a liquid crystal television, a monitor, and a mobile phone. One of ways to further enhance such advantages is to improve an illumination device (a so-called backlight) provided on a rear side of a liquid crystal display device.

Illumination devices are roughly classified into a sidelight type (also called “edge-light type”) and a direct type. A sidelight-type illumination device has an arrangement in which (i) a light guide (light guide plate) is provided on a rear side of a liquid crystal display panel and (ii) a light source is provided at a lateral end of the light guide. Light emitted from the light source is reflected by the light guide so that the liquid crystal display panel is illuminated with the light indirectly and uniformly. An illumination device having the arrangement can have a thin body and is excellent in luminance uniformity, although it has a low luminance. For this reason, the sidelight-type illumination device is mainly employed in a medium/small liquid crystal display device, such as a mobile phone and a laptop computer.

Meanwhile, the direct-type illumination device has an arrangement in which a plurality of light sources are provided on a rear side of a liquid crystal display panel so as to directly irradiate the liquid crystal display panel with light. Accordingly, a direct-type illumination device can easily achieve a high luminance, even if it has a large screen. For this reason, the direct-type illumination device is mainly employed in a large liquid crystal display device having a 20-inch or larger screen. However, a current direct-type illumination device has a thickness in a range of approximately 20 mm to 40 mm. This is an obstacle to make a further thinner display.

One of ways to cause a large liquid crystal display to have a less thickness is to reduce a distance between a light source and a liquid crystal display panel. In this case, however, the illumination device has a reduction in luminance uniformity. In order to avoid such a reduction in luminance uniformity, it is necessary to increase the number of light sources provided in the illumination device. The increase in the number of light sources leads to an increase in cost. Therefore, there has been demand for development of an illumination device which has a thin body and is excellent in luminance uniformity, without an increase in the number of light sources.

In order to solve the foregoing problems, an optical member, such as a diffusing plate, has been conventionally provided between a light guide and a liquid crystal display panel.

However, in a case where an optical member is merely provided between the light guide and the liquid crystal display panel, it is impossible to prevent generation of dark lines and bright lines in separation sections between neighboring individual light guides. This causes the illumination device to be poor in luminance uniformity.

Alternatively, in order to cause a large crystal display to have a thin body, a plurality of light guide units are arranged in an illumination device, while, for luminance uniformity, spacers or the like are provided in the illumination device so as to maintain a space (airspace) between an optical member (such as a prism sheet or a diffusing sheet) and a light exit plane.

For example, Patent Literature 1 describes a diffusing plate supporting member 122 which includes (i) a base 122a that is immobilized to a housing 112 that holds a cold-cathode fluorescent tube (light source), the base 122a and (ii) a columnar support 122b whose top end is in contact with a diffusing plate 115. The base 122a has been given a light shielding property, while the top end of the columnar support 122b is made from a transparent material (see FIG. 14).

Further, Patent Literature 2 describes a light guide unit 200 which includes (i) a plane fluorescent lamp 203 having a light emitting surface, (ii) a diffusing plate 206 provided on a light emitting surface side of the plane fluorescent lamp 203, and (iii) a support member 207 provided on the light emitting surface side of the plane fluorescent lamp 203 to support the diffusing plate 206. The support member 207 includes a base 271 and a support projection 272.

### CITATION LIST

### Patent Literature

Patent Literature 1
Japanese Patent Application Publication, Tokukai, No. 2007-157451 A (Publication Date: Jun. 21, 2007)
Patent Literature 2
Japanese Patent Application Publication, Tokukai, No. 2008-021583 A (Publication Date: Jan. 31, 2008)

### SUMMARY OF INVENTION

### Technical Problem

The diffusing plate supporting member 122 described in the above Patent Literature 1 suppresses a reduction in use efficiency of light. However, the diffusing plate supporting member 122 is provided on a reflecting sheet 119 as a different member and their materials are different from each other. This increases (i) the number of components and (ii) production costs, in production of a backlight device employing the diffusing plate supporting member 122.

Further, the light guide unit 200 described in Patent Literature 2 prevents an optical plate member from bending. However, the support member 207 is provided on the light emitting surface side of the plane fluorescent lamp 203 as a different member and a material of the support member 207 and a material of the light emitting surface of the plane fluorescent lamp 203 are different from each other. This increases (i) the number of components and (ii) a production cost.

The present invention is made in view of the problems. One of objects of the present invention is to provide a light guide and a surface light source device, each of which (i) is excellent in luminance uniformity and (ii) can reduce the number of components and a production cost.

Further, another object of the present invention is to provide a liquid crystal display device that has excellent display quality by employing the surface light source device as a backlight.

### Solution to Problem

A light guide of the present invention includes: a main body of a light guide plate, which main body has a light incident plane and a light exit plane; and at least one distance maintaining section for maintaining a distance between the light exit plane and an optical member for receiving light emitted from the light exit plane, the at least one distance maintaining section being provided on the light exit plane, the optical member being placed to face the light exit plane, the at least one distance maintaining section (i) being provided to extend from the light exit plane to the optical member, (ii) having a length of not less than 0.3 mm but not more than 50 mm in a direction in which the light exit plane and the optical member are connected to each other via the at least one distance maintaining section, and (iii) being provided integral with the main body of the light guide plate.

According to the arrangement, the distance maintaining section can maintain a predetermined space (distance) between the light exit plane and the optical member for receiving the light emitted from the light exit plane, which optical member is placed to face the light exit plane. That is, it is possible to maintain the space defined by the length (not less than 0.3 mm but not more than 50 mm) of the distance maintaining section in the direction in which the light exit plane and the optical member are connected to each other via the distance maintaining section. Therefore, overlapping of pieces of the light emitted from the light exit plane occurs in multiple directions in the space so that luminance of the light becomes uniform. It is thus possible to improve luminance uniformity.

Further, according to the arrangement, the distance maintaining section is provided integral with the main body of the light guide plate. Therefore, it is unnecessary to prepare the distance maintaining section as a member independent of the light guide. It is thus possible to have a reduction in the number of components and a reduction in production cost.

Further, it is preferable to arrange the light guide of the present invention such that the light guide (i) has a light emitting section having a light emitting surface, and a light guiding section for guiding light from the light incident plane to the light emitting section, and (ii) is arranged such that a light emitting section of each light guide overlaps a light guiding section of a neighboring light guide so as to partially cover the neighboring light guide.

This makes it possible for the light guide of the present invention to secure a wide light emitting area with a compact structure. Therefore, the light guide of the present invention can be suitably used in a large liquid crystal display.

Furthermore, it is preferable to arrange the light guide of the present invention such that the at least one distance maintaining section is provided on a light exit plane of the light guiding section so as to penetrate, but not in contact with, a light emitting section of a neighboring light guide.

According to the arrangement, the light guide of the present invention can prevent occurring of luminance non-uniformity because the distance maintaining section is provided on the light guiding section which is hardly illuminated with the light emitted from the light incident plane. Further, the distance maintaining section penetrates the light emitting section of the neighboring light guide. Therefore, it is possible to maintain a predetermined space between the light exit plane and the predetermined optical member, which faces the light exit plane.

Moreover, it is preferable to arrange the light guide of the present invention such that the at least one distance maintaining section is provided, on the light exit plane of the light guiding section, in at least one of two regions which are located on a light incident plane side with respect to corresponding two straight lines, which extend from a center of the light incident plane in different directions, respectively, at an angle of 35° with respect to a straight line that connects a center of the light incident plane and a center of the light guide to each other.

According to the arrangement, it is possible to further prevent the occurrence of luminance non-uniformity.

Further, it is preferable to arrange the light guide of the present invention such that the at least one distance maintaining section has a side surface that has been roughened, and the side surface has an arithmetic average roughness (Ra) of not less than 0.5 μm but not more than 10 μm.

According to the arrangement, it becomes possible to cause the light incident on the distance maintaining section to be easily emitted from the distance maintaining section without being reflected by the distance maintaining section. It is thus possible for the light guide of the present invention to suppress the luminance non-uniformity.

Furthermore, it is preferable to arrange the light guide of the present invention such that a cross-sectional area of the at least one distance maintaining section, along a plane parallel to the light exit plane, becomes smaller as being closer from one of ends of the at least one distance maintaining section, on the main body of the light guide plate, to the other one of ends.

According to the arrangement, a contact area between the distance maintaining section and the optical member becomes small. It is thus possible to further prevent the occurrence of luminance non-uniformity.

Moreover, it is preferable to arrange the light guide of the present invention such that for each main body of the light guide plate, the at least one distance maintaining section (i) is provided one by one or (ii) includes a plurality of distance maintaining sections.

The number of the distance maintaining sections of the light guide of the present invention is not particularly limited, provided that at least one distance maintaining section is provided. The less the number of the distance maintaining section is, the more successfully the luminance non-uniformity can be suppressed. On the other hand, the greater the number of the distance maintaining sections is, the more physical strength a surface light source device (illumination device) employing the light guide has.

Further, a surface light source device of the present invention preferably includes: the light guide; a substrate on a light incident plane side of the light guide; a light source provided on the substrate; and an optical member provided on a light exit plane side of the light guide. Furthermore, a surface light source device of the present invention preferably includes: a plurality of light guides; a substrate provided on a light incident plane side of the plurality of light guides; a light source provided on the substrate; and an optical member provided on a light exit plane side of the plurality of light guides. Further, the surface light source device of the present invention preferably includes a reflecting sheet on an opposite side of the light exit plane of the light guide.

According to the arrangement, the surface light source device of the present invention can cause light, which has been caused to be uniform by overlapping of pieces of light in multiple directions in the space between the light emitting surface and the optical member, to be more uniform by use of the optical member. It is thus possible to further improve the luminance uniformity.

Moreover, it is preferable to arrange the surface light source device of the present invention such that the light source is a light emitting diode which is provided on the substrate.

With the arrangement, the surface light source device of the present invention has a wide color reproducibility range.

Further, it is preferable to arrange the surface light source device of the present invention such that the optical member includes a diffusing plate which is formed such that diffusing particles are dispersed in a substrate which (i) is made from a transparent resin and (ii) has a thickness in a range of 0.5 mm to 3 mm.

With the arrangement, the surface light source device of the present invention can further improve the luminance uniformity.

Furthermore, a liquid crystal display device of the present invention preferably includes the surface light source device as a backlight.

According to the arrangement, the liquid crystal display device of the present invention includes, as the backlight, the surface light source device that has a thin body and an improvement in luminance uniformity without a reduction in luminance. It is thus possible to realize a liquid crystal display device that has a thin body and is excellent in display quality.

### Advantageous Effects of Invention

As described above, a light guide of the present invention includes: a main body of a light guide plate, which main body has a light incident plane and a light exit plane; and at least one distance maintaining section for maintaining a distance between the light exit plane and an optical member for receiving light emitted from the light exit plane, the at least one distance maintaining section being provided on the light exit plane, the optical member being placed to face the light exit plane, the at least one distance maintaining section (i) being provided to extend from the light exit plane to the optical member, (ii) having a length of not less than 0.3 mm but not more than 50 mm in a direction in which the light exit plane and the optical member are connected to each other via the at least one distance maintaining section, and (iii) being provided integral with the main body of the light guide plate.

Therefore, the light guide of the present invention (i) is excellent in luminance uniformity and (ii) can have a reduction in the number of components and a reduction in cost.

### BRIEF DESCRIPTION OF DRAWINGS

FIG. 1 is a cross-sectional view schematically illustrating an arrangement of a light guide in accordance with one embodiment of the present invention.

FIG. 2 is a cross-sectional view schematically illustrating an arrangement of a liquid crystal display device in accordance with one embodiment of the present invention.

FIG. 3 is a perspective view schematically illustrating an arrangement of an illumination device included in the liquid crystal display device illustrated in FIG. 2.

FIG. 4 is a perspective view schematically illustrating an arrangement of a light guide unit included in the liquid crystal display device illustrated in FIG. 2.

FIG. 5 is a cross-sectional view schematically illustrating which directions pieces of light are emitted from a light emitting surface of the light guide illustrated in FIG. 1.

FIG. 6 is a cross-sectional view schematically illustrating the arrangement of the light guide unit included in the liquid crystal display device illustrated in FIG. 2.

FIG. 7 is an explanatory view illustrating a side shape of and a bottom shape of a distance maintaining section in accordance with one embodiment of the present invention.

FIG. 8 is an explanatory view illustrating a side shape of the distance maintaining section in accordance with one embodiment of the present invention.

FIG. 9 is a perspective view schematically illustrating the arrangement of the light guide unit included in the liquid crystal display device illustrated in FIG. 2.

FIG. 10 is a cross-sectional view schematically illustrating an arrangement of a liquid crystal display device in accordance with Embodiment 2 of the present invention.

FIG. 11 is a plan view schematically illustrating an arrangement of an illumination device included in the liquid crystal display device illustrated in FIG. 10.

FIG. 12 is a perspective view schematically illustrating an arrangement of a light guide unit included in the illumination device illustrated in FIG. 11.

FIG. 13 is a view illustrating a light guide unit included in the liquid crystal display device illustrated in FIG. 10: (a) of FIG. 13 is a plan view taken from a liquid crystal display panel side; (b) of FIG. 13 is a plan view taken from an illumination device side; and (c) of FIG. 13 is a cross-sectional view of the light guide unit illustrated in (a) of FIG. 13, taken along a line A-A.

FIG. 14 is a cross-sectional view illustrating a side shape of a conventional distance maintaining section.

FIG. 15 is a cross-sectional view illustrating a side shape of another conventional distance maintaining section.

### DESCRIPTION OF EMBODIMENTS

### Embodiment 1

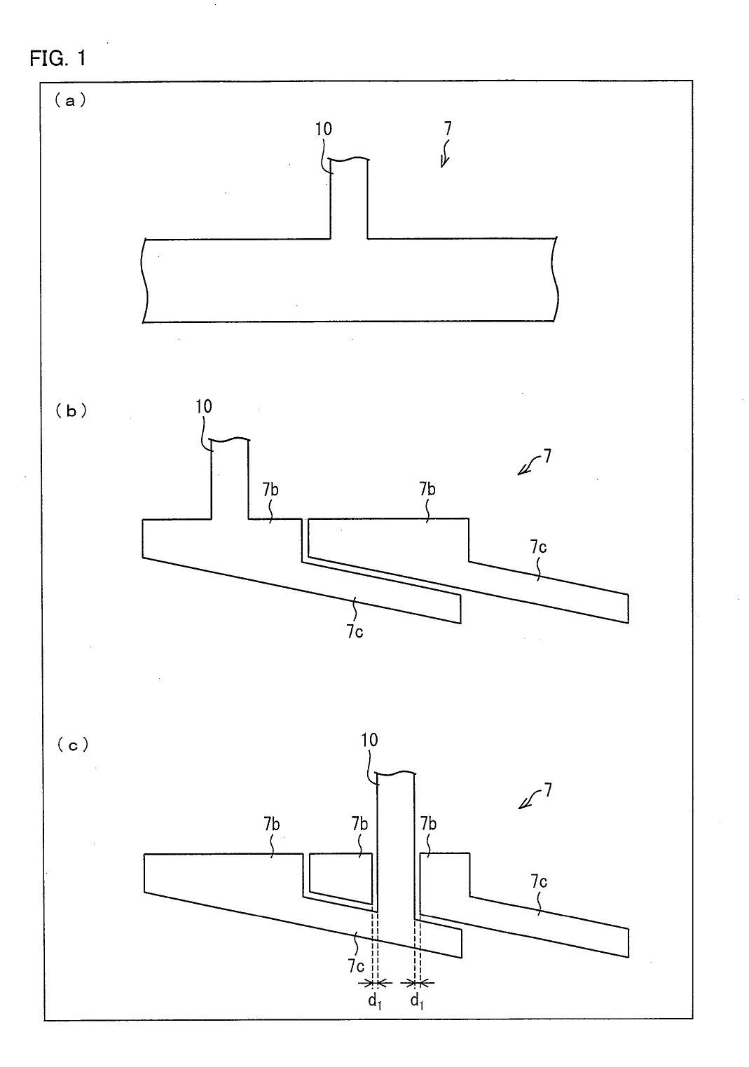

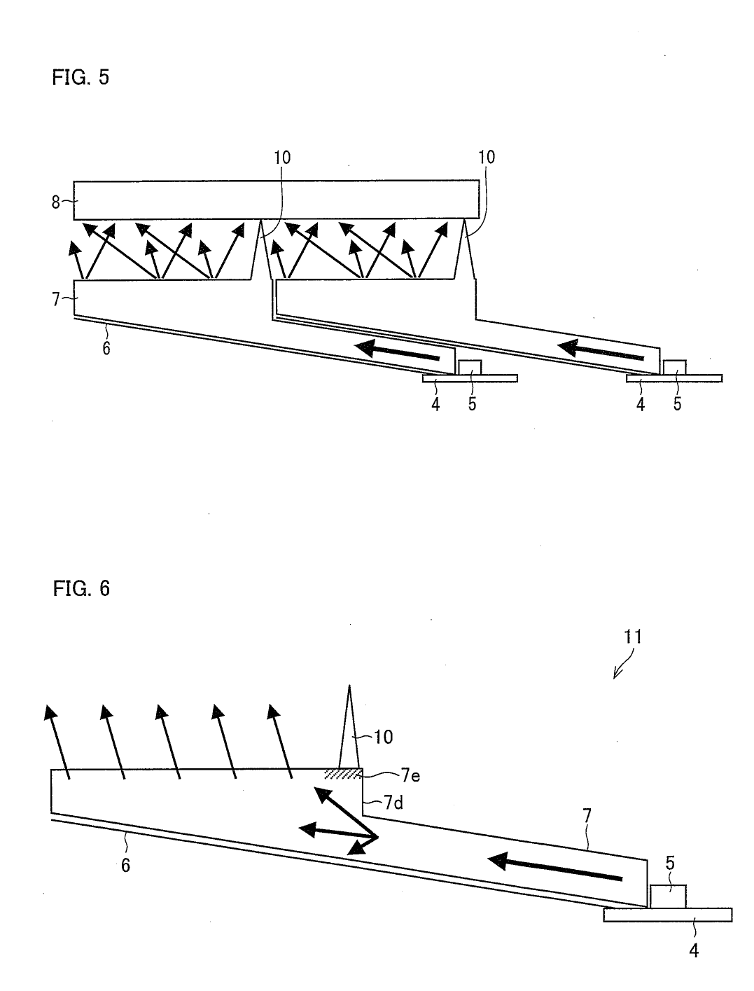

One embodiment of the present invention is described below with reference to FIGS. 1 through 9. Note that the present invention is not limited to this, and descriptions as to a size of, a material of, a shape of, and a relative arrangement of each of components described in the present specification are not intended to limit the scope of the present invention but are merely described as examples of the present invention, unless otherwise noted. Note that in the present specification, an expression of “A-B” stands for a range of “not less than A but not more than B”.

Each of (a) through (c) of FIG. 1 is a cross-sectional view schematically illustrating an arrangement of a light guide 7 of the present embodiment.

Specifically, (a) of FIG. 1 is a cross-sectional view illustrating the light guide 7 that includes (i) a main body of a light guide plate (a part of the light guide other than a distance maintaining section 10), which main body has a light incident plane and a light exit plane, and (ii) the distance maintaining section 10 that is provided on the light exit plane as being integral with the main body of the light guide plate.

Further, (b) of FIG. 1 is a cross-sectional view illustrating the light guide 7 that includes (i) a main body of a light guide plate, which main body has a light incident plane and a light exit plane, (ii) a distance maintaining section 10 that is provided on the light exit plane as being integral with the main body of the light guide plate, (iii) a light emitting section 7b having a light emitting surface, and (iv) a light guiding section 7c for leading light incident on the light incident plane to the light emitting section 7b. A light emitting section 7b of a neighboring light guide overlaps the light guiding section 7c of the light guide so as to partially cover the light guide.

Furthermore, (c) of FIG. 1 is a cross-sectional view illustrating a light guide 7 that includes (i) a main body of a light guide plate, which main body has a light incident plane and a light exit plane, (ii) a distance maintaining section 10 that is provided on the light exit plane as being integral with the main body of the light guide plate, (iii) a light emitting section 7b having a light emitting surface, and (iv) a light guiding section 7c for leading light incident on the light incident plane to the light emitting section 7b. A light emitting section 7b of a neighboring light guide overlaps the light guiding section 7c of the light guide so as to partially cover the light guide. The distance maintaining section 10 is provided on the light exit plane of the light guiding section 7c of the light guide so as to penetrate, but not in contact with, a light emitting section 7b of the neighboring light guide.

In the arrangement illustrated in (c) of FIG. 1, it is preferable that a distance d1 between the distance maintaining section 10 and the light emitting section 7b of the neighboring light guide is as short as possible but the distance maintaining section 10 and the light emitting section 7b of the neighboring light guide are not in contact with each other.

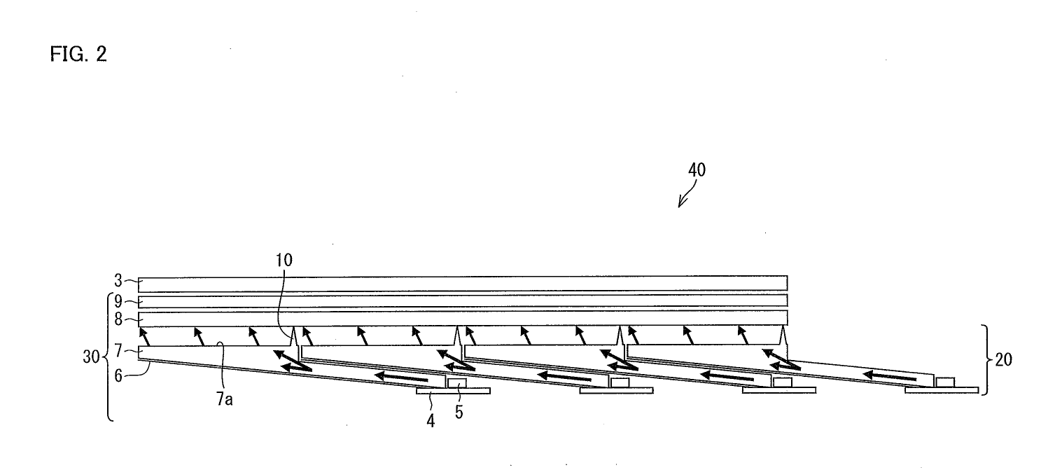

FIG. 2 is a cross-sectional view schematically illustrating an arrangement of a liquid crystal display device 40 of the present embodiment. The liquid crystal display device 40 includes a surface light source device 30 and a liquid crystal display panel 3 that is provided to face the surface light source device 30. Note that, in the present specification, the surface light source device 30 includes a backlight (illumination device) 20 and a diffusing plate (optical member) 8 that is provided on a rear side of the liquid crystal display panel 3 (a side opposite to a display surface). It is preferable that the surface light source device 30 further includes an optical sheet 9 in the rear side of the liquid crystal display panel 3 (the side opposite to the display surface).

The liquid crystal display panel 3 is similar to a general liquid crystal display panel employed in a conventional liquid crystal display device. For example, the liquid crystal display panel 3 has an arrangement (not illustrated though) in which (i) an active matrix substrate on which a plurality of TFTs (thin film transistors) are provided and a CF substrate are provided to face each other and (ii) a liquid crystal layer is sealed, with a sealing material, between the substrates.

Arrangements of the backlight 20 and the surface light source device 30, which are included in the liquid crystal display device 40, are described below in detail.

The backlight 20 and the surface light source device 30 are provided at the rear side of the liquid crystal display panel 3 (the side opposite to the display surface). The surface light source device 30 is mainly constituted by a substrate 4, a light source 5, a reflecting sheet 6, a light guide 7, a diffusing plate (optical member) 8, and, if necessary, an optical sheet 9 (see FIG. 2).

The light guide 7 leads light emitted from the light source 5 to the light emitting surface 7a (the light exit plane of the light emitting section 7b) so that the light is emitted from the light emitting surface 7a. The light emitting surface 7a is a surface via which light is emitted toward an illumination target. According to the present embodiment, the light guide 7 has a tandem structure (see FIG. 2). That is, (i) the light guide 7 includes the light emitting section 7b having the light emitting surface 7a and a light guiding section 7c via which light is led from the light source 5 to the light emitting section 7b, (ii) the light emitting section 7b and the light guiding section 7c are different from each other in thickness in at least a connection part between the light emitting section 7b and the light guiding section 7c, and (iii) a light emitting section 7b of each light guide 7 overlaps a light guiding section 7c of a neighboring light guide 7 so as to partially cover the neighboring light guide 7. With the arrangement, one uniform light emitting plane is constituted by a plurality of light guides 7.

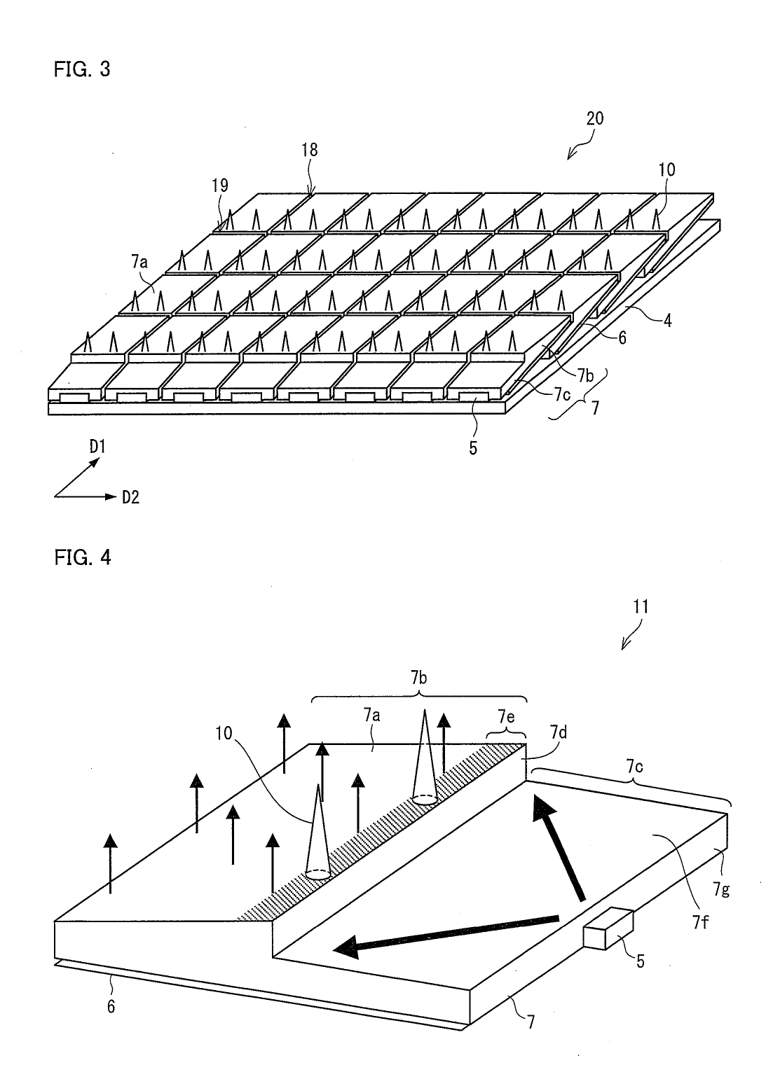

Further, FIG. 3 is a perspective view illustrating the backlight 20. Note that the backlight 20 of the liquid crystal display device 40 of the present embodiment has a plurality of gaps 18 and a plurality of gaps 19, due to its production mechanism. Each of the plurality of gaps 18 is formed between neighboring light guides 7 arranged in a direction in which the neighboring light guides 7 do not overlap each other, whereas each of the plurality of gaps 19 is formed between neighboring light guides 7 arranged in a direction in which the neighboring light guides 7 overlap each other.

Here, “D1 direction” is a direction in which a light emitting section 7b of each light guide 7 overlaps a light guiding section 7c of a neighboring light guide 7 so as to partially cover the neighboring light guide 7 (see FIGS. 2 and 3). In the D1 direction, a plurality of light guides 7 are arranged so that neighboring light guides 7 overlap each other. Further, “D2 direction” is a direction which intersects the D1 direction (substantially orthogonal to each other). In the D2 direction, the plurality of light guides 7 are arranged but do not overlap each other.

Each of the plurality of gaps 18 is formed between neighboring light guides 7 arranged in the direction in which the neighboring light guides 7 do not overlap each other, that is, between neighboring light guides 7 arranged in the D2 direction (see FIGS. 2 and 3). In other words, the plurality of light guides 7 have no overlapping part between them in the D2 direction.

On the other hand, each of the plurality of gaps 19 is formed between neighboring light emitting surfaces 7a of neighboring light guides 7, in a case where a light emitting section 7b of one of the neighboring light guides 7 overlaps a light guiding section 7c of the other one of the neighboring light guides 7 so as to partially cover the other one of the neighboring light guides 7 (see FIGS. 2 and 3). That is, each of the plurality of gaps 19 is formed between neighboring light guides 7 arranged in the D1 direction, as illustrated in FIGS. 2 and 3.

As described above, the backlight 20 of the liquid crystal display device 40 of the present embodiment is a tandem-type illumination device in which a plurality of light guides 7 are arranged such that a light emitting section 7b of each light guide 7 overlaps a light guiding section 7c of a neighboring light guide 7 so as to partially cover the neighboring light guide 7. The tandem-type illumination device has (i) the plurality of gaps 18 each being formed between neighboring light guides 7 arranged in the direction in which the neighboring light guides 7 do not overlap each other and (ii) the plurality of gaps 19 each being formed between neighboring light guides 7 arranged in the direction in which the neighboring light guides 7 overlap each other.

Other than the gaps described above, there are various factors that cause a reduction in luminance uniformity of the backlight 20, such as a light emitting property of the light source and a shape of the light guide.

The following description deals with how luminance non-uniformity occurs with reference to FIGS. 4 through 6.

Each of FIGS. 4 through 6 illustrates how the light emitted from the light source 5 travels in the light guide 7. The light emitted from the light source 5 enters the light guiding section 7c of the light guide 7 at a certain critical angle (see FIG. 4). The light that has entered the light guiding section 7c travels to the light emitting section 7b while diffusing in a radial pattern in the light guiding section 7c. Then, the light is reflected by reflecting sheet 6 provided at a back surface of the light emitting section 7b, after that, is emitted from the light emitting surface 7a. Here, in general, light tends to be reduced in amount as being farther away from the light source 5. Therefore, in a region of one of ends of the light guide 7, which end is the one farther away from the light source 5, a light amount is smaller than those in other regions.

Further, since the light guiding section 7c of the light guide 7 and the light emitting section 7b of the light guide 7 are different from each other in thickness, a step 7d is formed at a border part between the light guiding section 7c and the light emitting section 7b. Due to the formation of the step 7d, a dark part 7e (dead space (see a part indicated by oblique lines in FIG. 4)) to which light is not likely to travel is generated. Accordingly, the dark part 7e has a smaller light amount than those of other regions. The light amount thus varies in accordance with a position on the light emitting surface 7a. Accordingly, luminance non-uniformity occurs.

Even if, in view of the problem described above, the diffusing plate 8 for diffusing light is provided directly on the light emitting surface 7a of the backlight 20, in which luminance uniformity is reduced, the diffusing plate 8 cannot sufficiently diffuse the light to be emitted from the backlight 20. Therefore, it is significantly difficult to realize a surface light source device 30 that is excellent in luminance uniformity. Further, the diffusing plate 8 can be made thicker or have a two-layer structure so as to realize a surface light source device 30 that is excellent in luminance uniformity. With such an arrangement, however, the luminance uniformity may be improved but there would be a reduction in luminance. The arrangement is therefore not preferable.

In view of the problems, the light guide 7 of the liquid crystal display device 40 of the present embodiment includes the distance maintaining section 10 formed on the light exit plane of the main body of the light guide plate. Note here that, in the present specification, “light exit plane” is constituted by the light emitting surface 7a and a light exit plane 7f which serves as a light exit plane of the light guiding section 7c. Further, “main body of the light guide plate” is a part of the light guide 7 other than the distance maintaining section 10.

FIG. 4 is a perspective view schematically illustrating an arrangement of a light guide unit 11 included in the liquid crystal display device 40 illustrated in FIG. 2. The light guide unit 11 diffuses light that has been emitted from the light source 5 via a light incident plane 7g so that the light is emitted from a light emitting surface. The light guide unit 11 is mainly constituted by a light source 5, a substrate 4 (see FIG. 2), a reflecting sheet 6, and a light guide 7. The light emitted from the light source 5 enters the light guiding section 7c of the light guide 7, and then travels to the light emitting section 7b in the light guiding section 7c (see FIG. 4). A surface (light emitting surface 7a) of or a back surface of the light emitting section 7b of the light guide 7 has been processed or treated (not illustrated) so that the light thus guided is emitted forward. The light is therefore emitted from the light emitting surface 7a of the light guide 7 toward the liquid crystal display panel 3.

The light guide 7 includes (i) the main body of the light plate (the part of the light guide 7 other than the distance maintaining section 10) having the light incident plane 7g and a light exit plane facing the light incident plane 7g and (ii) the distance maintaining section 10 provided on the light exit plane of the main body of the light guide plate. The distance maintaining section 10 is provided integral with the main body of the light guide plate.

Accordingly, the surface light source device 30 included in the liquid crystal display device 40 of the present embodiment has an arrangement in which the distance maintaining section 10 is provided between the light exit plane (light emitting surface 7a) and the diffusing plate 8 which is a target to be illuminated so that the light exit plane and the diffusing plate 8 face each other with a predetermined distance between them (see FIG. 2).

In other words, since the distance maintaining section 10 maintains a constant space between a plurality of light exit planes (light emitting surfaces 7a) and the diffusing plate 8, overlapping of pieces of the light emitted from the plurality of light exit planes (light emitting surfaces 7a) occurs in multiple directions in the space between the plurality of light exit planes (light emitting surfaces 7a) and the diffusing plate 8. This causes the light in the surface light source device 30 to be uniform. It becomes therefore possible to improve the luminance uniformity.

Further, since the distance maintaining section 10 causes the diffusing plate 8 or the optical sheet 9 and the light guide 7 to be provided with a predetermined distance between them, it is possible to have, in addition to the effect of prevention of occurrence of the luminance non-uniformity, an effect of appropriately protecting a surface of the diffusing plate 8 or a surface of the optical sheet 9, as compared with an arrangement in which the diffusing plate 8 or the optical sheet 9 is in contact with the light guide 7. The following description deals with the distance maintaining section 10 in detail.

<Shape etc. of Distance Maintaining Section>

The distance maintaining section 10 is provided on the light exit plane so as to maintain a predetermined distance between the light exit plane and a predetermined optical member that faces the light exit plane. The distance maintaining section 10 has a length of not less than 0.3 mm but not more than 50 mm in a direction in which the light exit plane and the optical member are connected to each other via the distance maintaining section 10, preferably, in a range of 0.2×P_{MAX}−1.5×P_{MAX}, where P_{MAX} is a maximum value of a pitch of the light sources 5 of the surface light source device 30 including the light guide 7. Further, the distance maintaining section 10 is provided so as to extend from the light exit plane to the optical member. Here, the predetermined optical member is an optical member employed in a device such as a liquid crystal display device or a surface light source device, for example. Specifically, the predetermined optical member is the diffusing plate 8 or the like, which will be described later. Furthermore, the predetermined distance is a distance necessary for causing the light emitted from the light exit plane (light emitting surface 7a) to be uniform by causing pieces of the light to overlap each other in multiple directions in a space between the light exit plane (light emitting surface 7a) and the diffusing plate 8. The predetermined distance is equal to the length of the distance maintaining section 10.

Further, according to the present embodiment, the distance maintaining section 10 is made from a material having optical transparency and optical diffuseness so as to prevent the light from being shielded or reflected by the distance maintaining section 10. With the distance maintaining section 10 made from the material having optical transparency and optical diffuseness, it is possible to reduce (i) an amount of light that is shielded by the distance maintaining section 10 and (ii) an amount of light that is reflected by the distance maintaining section 10. Furthermore, the distance maintaining section 10 made from such a material does not prevent traveling of the light emitted from the light emitting surface. Therefore, it is possible to suppress a reduction in luminance and a reduction in luminance uniformity.

The material having optical transparency and optical diffuseness may be, for example, the one obtained by mixing, in a transparent resin such as an acrylic resin or a polycarbonate, particles made from a material having a light scattering property such as an oxidized titanium or a barium sulfate. Note that it is preferable to make the distance maintaining section 10 from the same material as that of the main body of the light guide plate.

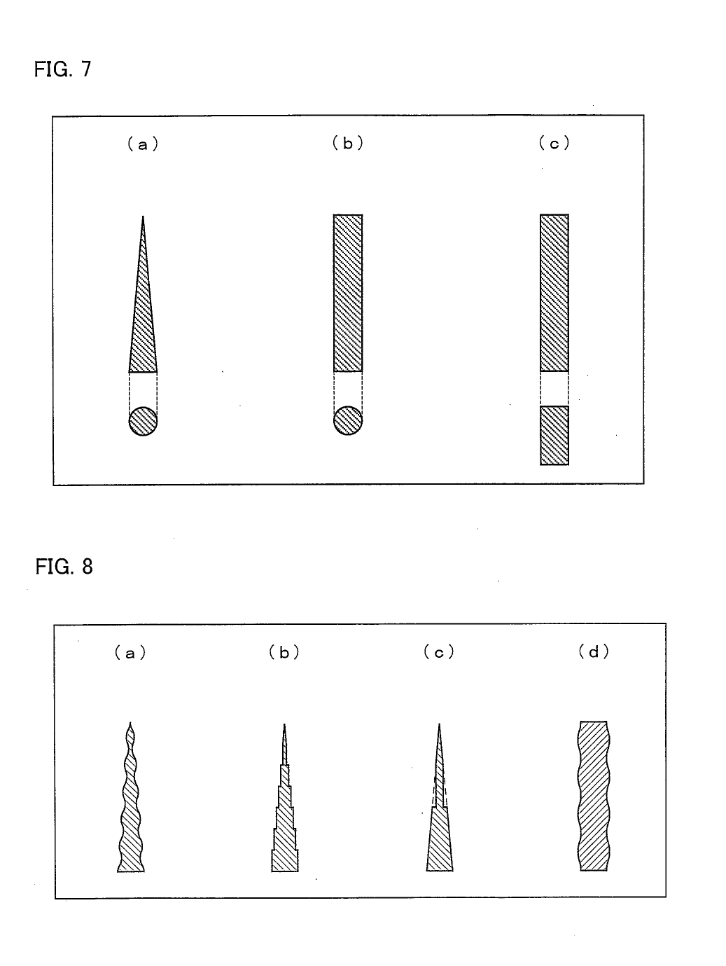

FIG. 7 is an explanatory view illustrating a shape of a side surface of and a shape of a bottom surface (a plane immobilized to the substrate) of the distance maintaining section 10.

(a) of FIG. 7 illustrates a distance maintaining section 10 having such a circular conic shape that (i) a cross-sectional shape viewed from a side is an isosceles triangle and (ii) a bottom plane has a circular shape. An end of the distance maintaining section 10, which end is in contact with the diffusing plate 8 or the optical sheet 9, has a relatively-pointed shape so that a contact area between the distance maintaining section 10 and the diffusing plate 8 or the optical sheet 9 is small. A shape meeting such a condition is not limited to a circular conic shape and can be a circular truncated conic shape. In the case of the circular truncated conic shape, a top plane (a plane to be in contact with the diffusing plate 8 or the optical sheet 9) has a circular shape.

(b) of FIG. 7 illustrates a distance maintaining section 10 having such a cylinder shape that (i) a cross-sectional shape viewed from a side is a columnar shape (such as a rectangle or a square) and (ii) each of a top plane (a plane to be in contact with the diffusing plate 8 or the optical sheet 9) and a bottom plane has a circular shape.

(c) of FIG. 7 illustrates a distance maintaining section 10 having such a prism shape that each of a cross-sectional shape viewed from a side, a top plane, and a bottom plane has a columnar shape (such as a rectangular shape or a square shape). Note that the shape illustrated in (c) of FIG. 7 can be modified such that the distance maintaining section 10 is tapered as being closer to one of its ends, which one of ends is in contact with the diffusing plate 8 or the optical sheet 9.

According to the present invention, the distance maintaining section 10 is not limited to the shapes described above. Note, however, that, in terms of light scattering property and the like, it is preferable that the contact area between the distance maintaining section 10 and the diffusing plate 8 or the optical sheet 9, which is an optical member, is as small as possible, provided that it can support the liquid crystal display panel 3 and the diffusing plate 8 and/or the optical sheet 9 without any problem.

Further, in order to cause the distance maintaining section 10 to isotropically have the light transparency and the light diffuseness, it is preferable to cause the distance maintaining section 10 to have a shape of a body of rotation. Therefore, it is preferable that the distance maintaining section 10 has a circular conic shape (illustrated in (a) of FIG. 7), a circular truncated conic shape, or a cylinder shape (illustrated in (b) of FIG. 7) rather than a prism shape (illustrated in (c) of FIG. 7).

Further, it is preferable that a side surface of the distance maintaining section 10 has been roughened. Each of (a) through (d) of FIG. 8 illustrates an example of a roughened side surface of the distance maintaining section 10. The side surface of the distance maintaining section 10 is not limited to the shapes illustrated in (a) through (d) of FIG. 8. For example, the side surface of the distance maintaining section 10 may have a shape having at least one groove.

Here, in the present specification, the length of the distance maintaining section 10 (the length of the distance maintaining section 10 in the direction in which the light exit plane and the optical member are connected via the distance maintaining section 10) is the shortest distance between the bottom plane of the distance maintaining section 10 (the plane facing the light exit plane) and the top plane (the plane facing the optical member) of or an apex (a contact point between the distance maintaining section 10 and the optical member) of the distance maintaining section 10.

Further, the side surface of the distance maintaining section 10 has an arithmetic average roughness (Ra) in a range of not less than 0.5 μm but not more than 10 μm, more preferably, in a range of not less than 0.5 μm but not more than 3 μm. Note that, in the present specification, an arithmetic average roughness (Ra) is a value obtained by carrying out measurement in compliance with JIS B 0601 (1994)/JIS B 0031 (1994).

Note that, in any of the arrangements described above, the number of distance maintaining sections 10 provided on the light emitting surface 7a is not particularly limited, provided that at least one distance maintaining section 10 is provided between the light emitting surface 7a and the diffusing plate 8 or the optical sheet 9.

<Position of Distance Maintaining Section>

A position of the distance maintaining section 10 is not particularly limited. Note, however, that it is preferable to provide the distance maintaining section 10 in a region having a low luminance on a plurality of light exit planes (light emitting surfaces 7a). This is because, in a case where the distance maintaining section 10 is provided in the region having a low luminance, it is possible to (i) reduce a ratio of light reflected by the distance maintaining section 10 in the light emitted from the plurality of light exit planes (light emitting surfaces 7a) and therefore (ii) suppress an influence of the distance maintaining section 10 on luminance distribution on the plurality of light exit planes (light emitting surfaces 7a).

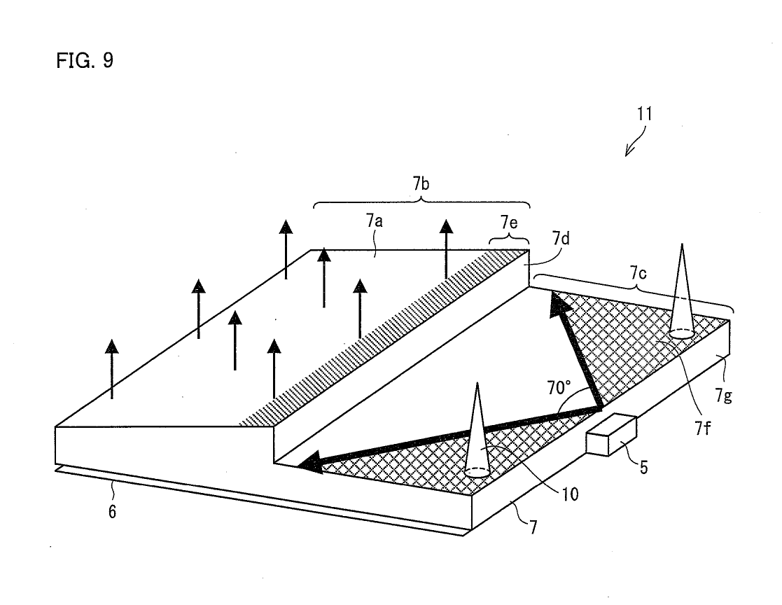

It is preferable to provide the distance maintaining section 10 on the light guiding section 7c of the light guide 7, more preferably in a region (a shaded region in FIG. 9) on the light exit plane of the light guiding section 7c, to which region the light emitted from the incident plane 7g does not travel. Specifically, the region on the light exit plane of the light guiding section 7c, to which region the light emitted from the incident plane 7g does not travel (hardly reaches), is a region on a light source 5 side with respect to light propagation path defined by a critical angle of 70° at which the light emitted from the light source 5 enters the light guiding section 7c of the light guide 7. That is, the light emitted from the incident plane 7g does not travel to two regions (shaded regions show in FIG. 9) which are located on the light incident plane 7g side (the light source 5 side) with respect to corresponding two straight lines B, which extend from a center of the light incident plane 7g, to right and left (directions parallel to the D2 direction shown in FIG. 3), respectively, at an angle of 35° (70° in total) with respect to a straight line A that connects the center of the light incident plane 7g and a center of the light guide 7 each other.

Note that the position of the distance maintaining section 10 is not particularly limited, provided that at least one distance maintaining section 10 is provided between the light emitting surface 7a and the diffusing plate 8 or the optical sheet 9.

<Main Body of Light Guide Plate>

The light emitting section 7b of the light guide 7 is subjected to a process or treatment, such as prism processing, texturing, or print processing. Note, however, that the process or treatment is not particularly limited, and can be selected appropriately from among known methods.

Further, as early described, the light guide 7 is mainly constituted by a transparent resin such as a PMMA and a polycarbonate, but the material of the light guide 7 is not particularly limited. Note, however, that it is preferable that the light guide 7 is made from a material having a high optical transparency. Note that, as early described, it is preferable that the main body of the light guide plate and the distance maintaining section 10 are made from the same material.

Furthermore, in order to form a shape of the light guide 7, various methods can be used such as injection molding, extrusion, hot press molding, and cutting. Note, however, that how to form a shape of the light guide 7 is not limited to the above methods, and any method can be employed, provided that the method has effects similar to those of the methods described above.

<Arrangement of Liquid Crystal Display Device Other than Light Guide>

The light source 5 may be a light emitting diode (LED) of a sidelight type, a cold cathode fluorescent tube (CCFL), or the like. In the following descriptions, the light source 5 is an LED, as an example. In a case where the light source 5 is a sidelight-type LED in which R, G, and B chips are molded in one package, it becomes possible to realize a surface light source device having a wide color reproducibility range. Note that the light source 5 is provided on the substrate 4.

The substrate 4 on which the light source 5 is provided is not particularly limited, but a white substrate is preferably used in terms of improvement in luminance. Note that a driver (not illustrated) for controlling each LED constituting the light source 5 to be turned on or off is provided on a back surface (a surface opposite to the surface on which the light source 5 is provided) of the substrate 4. That is, the driver and the LED are provided on the same substrate 4. With the arrangement in which the driver and the LED are provided on the same substrate, it becomes possible to (i) reduce the number of substrates, (ii) reduce the number of components such as a connector for connecting substrates to each other, and therefore (iii) reduce a production cost of the device. Further, the reduction in the number of substrates allows manufacture of a thinner liquid crystal display device 40.

The reflecting sheet 6 is provided so as to be in contact with the back surface (the surface opposite to the light emitting surface 7a) of the light guide 7. The reflecting sheet 6 reflects light so as to cause the light emitting surface 7a to emit light as much as possible.

The diffusing plate (optical member) 8 is provided to face an entire one light emitting surface constituted by a plurality of light emitting surfaces 7a of the respective light guides 7 so as to cover the entire one light emitting surface with a predetermined distance between them. The diffusing plate 8 diffuses light emitted from the light emitting surface 7a of the light guide 7 and emits the light thus diffused to the optical sheet 9 (later described). Examples of the diffusing plate 8 encompass a prism sheet and a diffusing sheet.

The optical sheet 9 is constituted such that a plurality of sheets are stacked with each other, and is provided on a front surface side of the light guide 7. The optical sheet 9 (i) causes the light emitted from the light emitting surface 7a of the light guide 7 to be uniform, (ii) condenses the light, and (iii) emits the light to the liquid crystal display panel 3. That is, examples of the optical sheet 9 encompass a diffusing sheet which condenses light while diffusing the light, a lens sheet which improves a luminance in a front direction (a direction toward the liquid crystal display panel 3) by condensing light, and a polarization reflecting sheet which improves a luminance of the liquid crystal display device 1 by allowing a certain polarization component of light to pass through the polarization reflecting sheet but reflecting other polarization components of the light. It is preferable to appropriately select a combination of these sheets in accordance with a price or performance of the liquid crystal display device 1.

With the arrangements of the respective members described above, the light emitted from the light source 5 (i) travels through the light guide 7 while being diffused and reflected in the light guide 7, (ii) is emitted from the light emitting surface 7a, (iii) passes through the diffusing plate 8 and the optical sheet 9, and ultimately (iv) reaches the liquid crystal display panel 3 (see FIG. 2).

### Embodiment 2

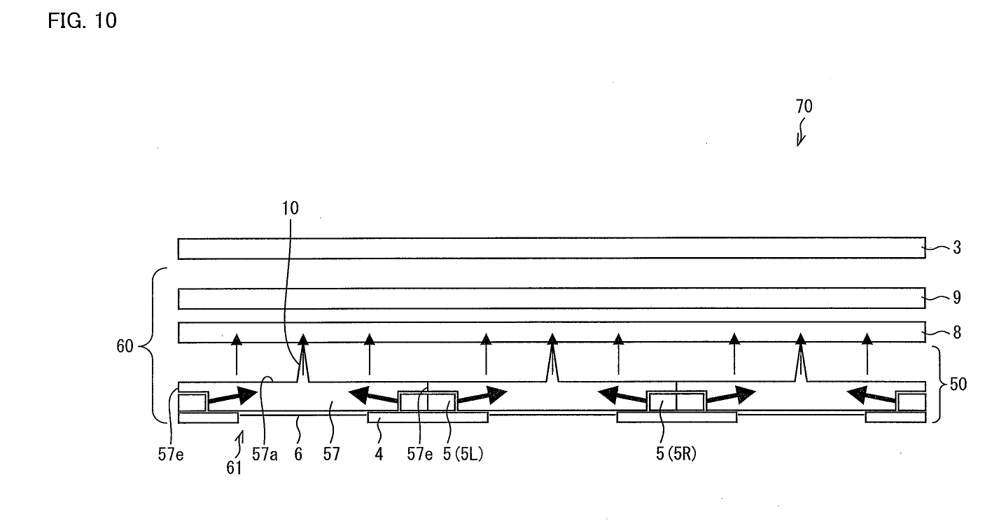

Another embodiment of a liquid crystal display device of the present invention is described below with reference to FIGS. 10 through 13. Note that members having the same functions as those of the members explained with drawings in Embodiment 1 are indicated with the same signs as those in Embodiment 1 for convenience. Their explanations are therefore omitted here.

According to Embodiment 1, a tandem-type backlight is explained. The present embodiment deals a tile-type backlight having an arrangement in which a plurality of light guides are arranged on the same plane but they do not overlap each other.

FIG. 10 is a cross-sectional view schematically illustrating an arrangement of a liquid crystal display device of the present embodiment. The liquid crystal display device 70 includes a surface light source device 60 and a liquid crystal display panel 3 which is provided to face the surface light source device 60. Note that, in the present specification, the surface light source device 60 includes a backlight (illumination device) 50 and a diffusing plate (optical member) 8 which is provided on a rear side (a side opposite to a display surface) of a liquid crystal display panel 3. It is preferable that the surface light source device 60 further includes an optical sheet 9 which is provided on the rear side (the side opposite to the display surface) of the liquid crystal display panel 3.

Next, the following description deals with an arrangement of the backlight 50 included in the liquid crystal display device 70.

The backlight 50 is provided on the rear side (the side opposite to the display surface) of the liquid crystal display panel 3. The backlight 50 includes a substrate 4, a light source 5, a reflecting sheet 6, a light guide 57, the diffusing plate 8, and, if necessary, the optical sheet 9 (see FIG. 10).

The light guide 57 causes light emitted from the light source 5 to be emitted from a light emitting surface 57a. The light guide 57 is substantially similar to the light guide 7 of Embodiment 1, except its shape. Particular similarities between the light guide 57 and the light guide 7 are that (i) the light guide 57 also includes a distance maintaining section 10 formed on a light exit plane of a main body (a part of the light guide other than the distance maintaining section 10) of a light guide plate, which main body has a light incident plane 57g and the light exit plane and (ii) the distance maintaining section 10 is also provided integral with the main body of the light guide plate. Note that a shape of the main body of the light guide plate is not particularly limited.

Components other than the light guide 57 are substantially similar to those of the backlight 20 of Embodiment 1. Their descriptions are therefore omitted here.

In the present embodiment, the backlight 50 is constituted by at least two light guides 57. That is, the backlight 50 is constituted such that a plurality of light guide units 61, each being constituted by a combination of a light guide 57 and two light sources 5, are arranged on the same plane.

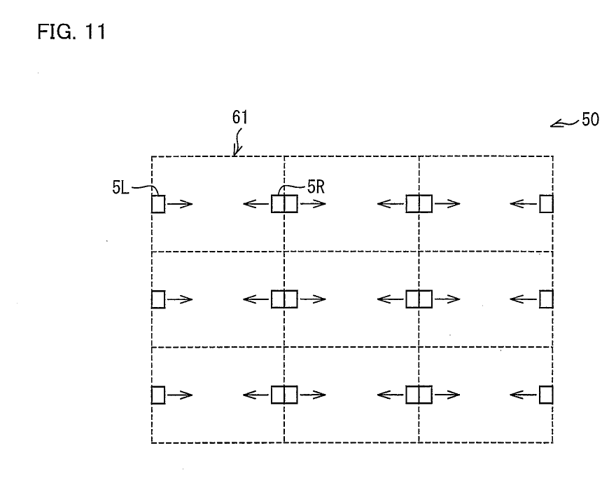

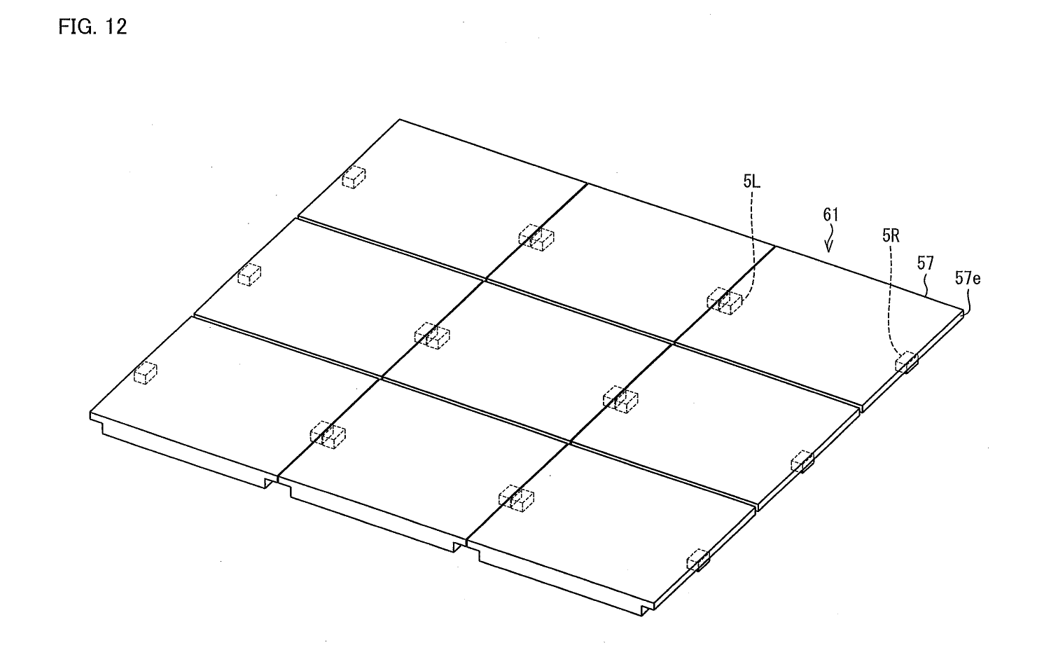

Further, FIG. 11 is a plan view schematically illustrating an arrangement of the backlight 50. The backlight 50 is constituted such that a plurality of light guide units 61, each including two light sources 5L and 5R (a pair of light sources), are arranged in matrix (see FIG. 11). As described above, the backlight 50 of the present embodiment has the arrangement in which a plurality of light guide units 61 are arranged like a plurality of tiles aligned with no space between them. The backlight 50 is therefore called “tile-type backlight”.

FIG. 12 is a perspective view illustrating a state where a plurality of light guide units 61 are arranged as shown in FIG. 11.

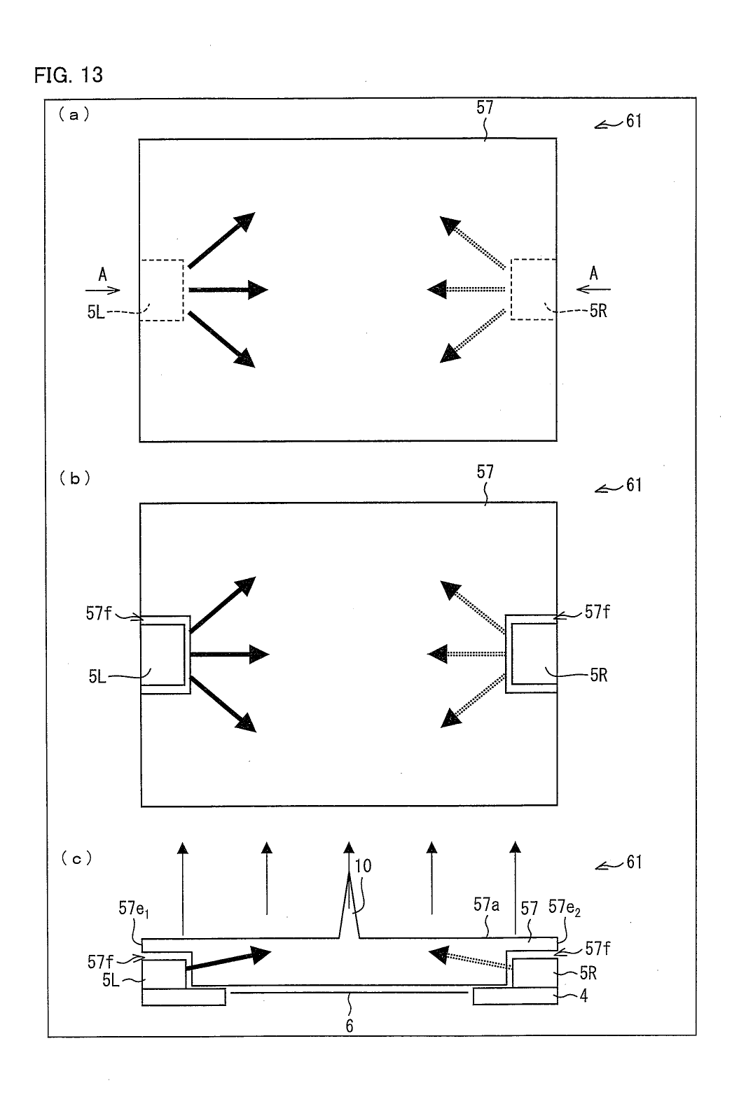

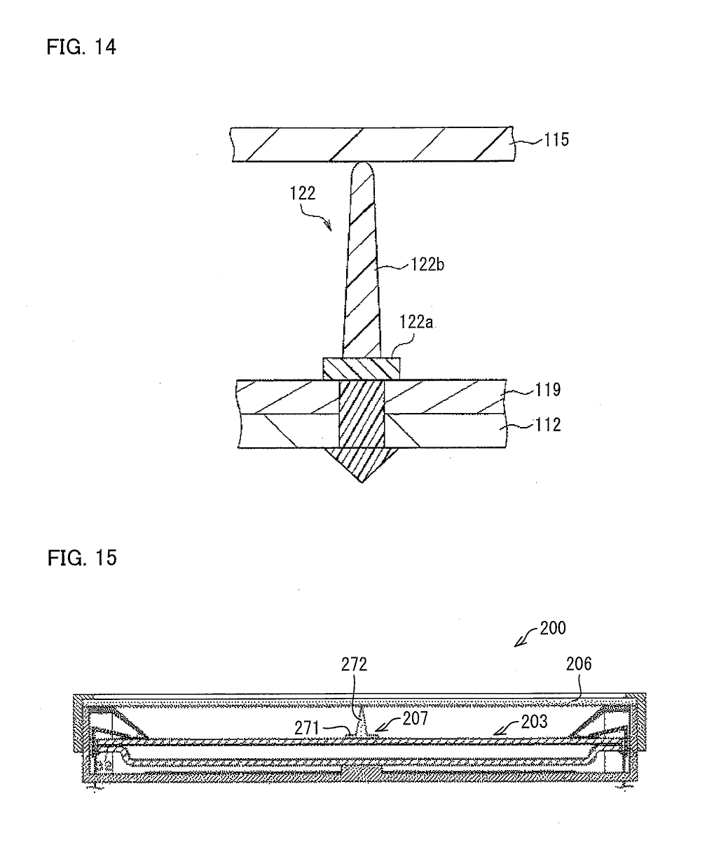

Further, FIG. 13 illustrates an arrangement of one of the plurality of light guide units 61 included in the backlight 50. (a) of FIG. 13 is a plan view (a top view) illustrating the light guide unit 61 when being viewed from a liquid crystal display panel 3 side (also called “top surface side”). (b) of FIG. 13 is a plan view (a bottom view) illustrating the light guide unit 61 when being viewed from a side opposite to the side of (a) of FIG. 13. (c) of FIG. 13 is a cross-sectional view illustrating the light guide unit 61 of (a) of FIG. 13, taken along the line A-A. The distance maintaining section 10 is formed on the light emitting surface 57a of the light guide 57 (see (c) of FIG. 13).

The light guide unit 61 illustrated in FIG. 13 includes the two light sources 5L and 5R (a pair of light sources) and the light guide 57 which causes light to be emitted from its light emitting surface. The light sources 5L and 5R are provided to face each other in respective concavities 57f which are formed inside the light guide 57. Note that the light sources 5L and 5R are provided on the substrate 4. Light emitting directions (arrows in full lines and arrows in dotted lines) of the light sources 5L and 5R are set so that the light sources 5L and 5R emit their light toward each other.

As described above, in the light guide unit 61, the two point light sources are provided to face each other so that a region to which light emitted from one of the point light sources does not travel is compensated by light emitted from the other, and vice versa.

According to the present embodiment, it is possible to realize a large backlight having no dark region by arranging a plurality of light guide units 61. Further, as illustrated in FIG. 10, the backlight 50 of the present embodiment has an arrangement in which the plurality of light guide units 61 are arranged on the same plane but neighboring light guide units 61 (a first light guide unit and a second light guide unit) do not overlap each other. Therefore, an entire light emitting surface (a light emitting region) of the backlight 50 is constituted by a plurality of light emitting surfaces 57a of the respective light guides 57.

As described above, the light emitted from the light source 5 (i) travels through the light guide 57 while being diffused and reflected in the light guide 57, (ii) is emitted from the light emitting surface 57a, (iii) passes through the diffusing plate 8 and the optical sheet 9, and ultimately (iv) reaches the liquid crystal display panel 3 (see FIG. 10).

Here, like a tandem-type backlight, a tile-type backlight has a problem that a bright line is generated due to a gap formed between neighboring two light guides. The generation of the bright line causes a reduction in luminance uniformity. The following description deals with how the luminance non-uniformity occurs.

The light emitted from the light source 5 is subjected to total reflection in the light guide 57 repeatedly, and is emitted from the light emitting surface 57a. However, a part of the light emitted from the light source 5 is not subjected to the total reflection in the light guide 57 but directly reaches one of end surfaces 57e, which is the one farther from the light source 5 (see (c) of FIG. 13). Such light has not had a reduction in light amount because it has not been subjected to the total reflection. Therefore, the light has a higher strength than that of the light emitted from the light emitting surface 57a. For this reason, the light emitted from the light source is directly emitted, to the outside, from a side plane 57e of the light guide. As a result, the light having the high strength appears as a bright line and luminance non-uniformity occurs as a whole.

In this regard, the light guide 57 included in the backlight 50 that is provided in the liquid crystal display device 70 of the present embodiment includes the distance maintaining section 10 formed on the light emitting surface 57a of the main body of the light guide plate.

Therefore, according to the arrangement of the present embodiment, it is possible to improve the luminance uniformity as compared with a conventional arrangement.

As described above, the liquid crystal display device 70 of the present embodiment includes the above backlight 50 so that the liquid crystal display panel 3 can be illuminated with more uniform light. Therefore, it is possible to improve display quality of the liquid crystal display device 70.

The present invention is not limited to the descriptions of the respective embodiments, but may be altered by a skilled person within the scope of the claims. An embodiment derived from a proper combination of technical means disclosed in different embodiments is also encompassed in the technical scope of the present invention.

That is, the embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a surface light source device which is used as a backlight of a liquid crystal display device or the like, and a liquid crystal display device or the like, including the surface light source device.

### REFERENCE SIGNS LIST

3: Liquid crystal display panel
4: Substrate
5: Light source
6: Reflecting sheet
7: Light guide
7a: Light emitting surface (of light guide)
7b: Light emitting section
7c: Light guiding section
7d: Step
7e: Dark part
7f: Light exit plane of light guiding section
7g: Light incident plane
8: Diffusing plate
9: Optical sheet
10: Distance maintaining section
11: Light guide unit
18: Gap
19: Gap
20: Backlight (illumination device)
30: Surface light source device
40: Liquid crystal display device
50: Backlight (illumination device)
57: Light guide
60: Surface light source device
61: Light guide unit
70: Liquid crystal display device

1. A light guide comprising:
a main body of a light guide plate, which main body has a light incident plane and a light exit plane; and
at least one distance maintaining section for maintaining a distance between the light exit plane and an optical member for receiving light emitted from the light exit plane, the at least one distance maintaining section being provided on the light exit plane, the optical member being placed to face the light exit plane,
the at least one distance maintaining section (i) being provided to extend from the light exit plane to the optical member, (ii) having a length of not less than 0.3 mm but not more than 50 mm in a direction in which the light exit plane and the optical member are connected to each other via the at least one distance maintaining section, and (iii) being provided integral with the main body of the light guide plate.

2. A light guide as set forth in claim 1, wherein:
the light guide (i) has a light emitting section having a light emitting surface, and a light guiding section for guiding light from the light incident plane to the light emitting section, and (ii) is arranged such that a light emitting section of each light guide overlaps a light guiding section of a neighboring light guide so as to partially cover the neighboring light guide.

3. The light guide as set forth in claim 2, wherein:
the at least one distance maintaining section is provided on a light exit plane of the light guiding section so as to penetrate, but not in contact with, a light emitting section of a neighboring light guide.

4. The light guide as set forth in claim 3, wherein:
the at least one distance maintaining section is provided, on the light exit plane of the light guiding section, in at least one of two regions which are located on a light incident plane side with respect to corresponding two straight lines, which extend from a center of the light incident plane in different directions, respectively, at an angle of 35° with respect to a straight line that connects the center of the light incident plane and a center of the light guide to each other.

5. The light guide as set forth in claim 1, wherein:
the at least one distance maintaining section has a side surface that has been roughened; and
the side surface has an arithmetic average roughness (Ra) of not less than 0.5 μm but not more than 10 μm.

6. The light guide as set forth in claim 1, wherein:
a cross-sectional area of the at least one distance maintaining section, along a plane parallel to the light exit plane, becomes smaller as being closer from one of ends of the at least one distance maintaining section, on the main body of the light guide plate, to the other one of ends.

7. The light guide as set forth in claim 1, wherein:
for each main body of the light guide plate, the at least one distance maintaining section (i) is provided one by one or (ii) includes a plurality of distance maintaining sections.

8. A surface light source device comprising:
a light guide recited in claim 1;
a substrate provided on a light incident plane side of the light guide;
a light source provided on the substrate; and
an optical member provided on a light exit plane side of the light guide.

9. A surface light source device comprising:
a plurality of light guides each being recited in claim 3;
a substrate provided on a light incident plane side of the plurality of light guides;
a light source provided on the substrate; and
an optical member provided on a light exit plane side of the plurality of light guides.

10. The surface light source device as set forth in claim 8, wherein:
the light source is a light emitting diode which is provided on the substrate.

11. The surface light source device as set forth claim 8, wherein:
the optical member includes a diffusing plate which is formed such that diffusing particles are dispersed in a substrate made from a transparent resin.

12. A liquid crystal display device comprising:
a surface light source device recited in claim 8, as a backlight.
